(19) United States
(12) Patent Application Publication
(10) Pub. No.: US 2018/0255363 A1
(43) Pub. Date: Sep. 6, 2018

(54) Method, System and Device for Implementation of Video Shopping

(71) Applicants: LE HOLDINGS (BEIJING) CO., LTD., Beijing (CN); LE SHI INTERNET INFORMATION & TECHNOLOGY CORP., BEIJING, Beijing (CN)

(72) Inventors: Yu ZHAO, BEIJING (CN); Shibin LI, Beijing (CN)

(21) Appl. No.: 15/119,632

(22) PCT Filed: May 27, 2016
(86) PCT No.: PCT/CN2016/083725

§ 371 Date: Aug. 17, 2016

(30) Foreign Application Priority Data
Nov. 25, 2015 (CN) 201510834374.8

(51) Int. Cl. H04N 21/478; G06F 3/0488; G06Q 30/02; G06Q 30/06

(52) U.S. Cl. CPC H04N 21/47815; G06F 3/04886; G06Q 30/0641; G06Q 30/0633; G06Q 30/0627; G06Q 30/0235

(57) ABSTRACT

Disclosed is a method, system and device for implementation of video shopping, the method comprising the steps of—adding a product tag for implementing a shopping function into a video; acquiring a touch signal within the display area of the video during the playback of the video; and if the touch signal is a first preset signal, then displaying the product tag of the video; and if the touch signal is a second preset signal, then retrieving a purchasing link of the product indicated by the second preset signal via the product tag and displaying the purchasing link.

### CROSS-REFERENCE TO RELATED APPLICATIONS

This application is a continuation of International Application No. PCT/CN2016/083725, filed on May 27, 2016, which is based upon and claims priority to Chinese Patent Application No. 2015108343748, filed on Nov. 25, 2015, the entire contents of which are incorporated herein by reference.

### TECHNICAL FIELD

The present disclosure relates to video control technology, in particular to a method, system and device for implementation of video shopping.

### BACKGROUND

When a user employs an existing touch-control device to watch a video, if the user wants to know or purchase a product appeared in the video, there are usually three methods that the first one is that the user needs to remember the features of the product and then search the web by himself, the second one is that some videos may be added with and display the description of a product when the videos are produced in advance, and the third one is that some other videos may provide a two-dimensional code for scanning to get the link of the product. In the course of implementing the present disclosure, the inventors have found that there are at least the following problems in prior art that the first method is more troublesome since the user has to search according to the feature keywords of the product and if the description of the product feature is not accurate then the corresponding product cannot be found; the second and the third methods has to take a part of video time to show the product information during video playing, which will affect the normal video watching of the other users who have no demand to purchase such product.

Most of the existing touch-control devices have touch gesture function, and the interface switching, parameter adjustment and other functions can be implemented by simple tapping, swiping, pinching and other gestures. But, in most of the video players, the tapping is often used to play and pause, the swiping is usually used to adjust the volume, brightness and video progress, and the pinching is usually used for partially zooming. The other gestures are inconvenient to be applied in the video player due to more complexity and potential misoperation.

### SUMMARY OF INVENTION

In view of this, an object of an embodiment of the present disclosure is to provide a method, system and device for implementation of video shopping for simplifying the operation process of video shopping and preventing the users from being affected to watch video normally.

Based on the above-described object of the embodiment of the present disclosure, it provides a method for implementation of video shopping, including:

adding a product tag for implementing a shopping function into a video;

acquiring a touch signal within a display area of the video during the playback of the video; and

if the touch signal is a first preset signal, then displaying the product tag of the video; or

if the touch signal is a second preset signal, then retrieving a purchasing link of the product indicated by the second preset signal via the product tag and displaying the purchasing link.

In some alternative embodiments, the product tag includes a menu product list which includes product information. The step of adding a product tag for implementing a shopping function into a video includes:

acquiring the product information of all products to be added; and

making a product list which includes the products using the product information.

In some alternative embodiments, the step of adding a product tag for implementing a shopping function into a video includes:

acquiring an incentive period for each product; and

adding each product into the product list according to the incentive period of each product; and

the step of acquiring the first preset signal and displaying the product tag includes:

acquiring the current time of the video when receiving the first preset signal; and

displaying the product list and determining whether the current time is in an incentive period of a product, and if yes, then displaying the product in the product list; if no, then hiding the product; and repeating the above process until all the products are traversed.

In some alternative embodiments, the product tag includes a product section, wherein the product section is an area including a single product displayed on the video screen and the product section is highlighted by bolding edges, masking, highlighting, etc.; and the step of adding a product tag for implementing a shopping function into a video includes:

acquiring the product information of all products to be added;

acquiring an incentive period for each product;

adding the product sections into the video according to the incentive period of each product; and

the step of acquiring the first preset signal and displaying the product section includes:

acquiring the current time of the video when receiving the first preset signal;

determining whether the current time is in an incentive period of any product, and if yes, then displaying the product section of the product; if no, then hiding the product section of the product; and repeating the above process until all the products are traversed.

In some alternative embodiments, the step of adding a product tag for implementing a shopping function into a video includes:

assigning a product tag identification number to the product tag;

acquiring a video identification information of the video and associating the video identification information with the product tag identification number; and

during the playback of the video, according to the video identification information of the current video, retrieving the product tag identification number associated with the video identification information of the current video, and loading the product tag corresponding to the product tag identification number.

In some alternative embodiments, the first preset signal is any one of light pressing, tapping, swiping and panning signals; the second preset signal is any one of heavy pressing, tapping, swiping and panning signals; and the second preset signal is different from the first preset signal.

Another aspect of an embodiment of the present disclosure provides a system for implementation of video shopping, including:

a tag setting module, for adding a product tag for implementing a video shopping function into a video;

a touch signal acquiring module, for playing a video and acquiring a touch signal within a display area of the video during the playback of the video; and

a tag management module, for identifying the touch signal; if the touch signal is a first preset signal, then controlling the touch signal acquiring module to display the product tag of the video;

or if the touch signal is a second preset signal, then retrieving a purchasing link of the product indicated by the second preset signal via the product tag and displaying the purchasing link.

In some alternative embodiments, the product tag includes a menu product list which includes product information; and wherein the tag setting module is used for acquiring the product information of all products to be added; and making a product list which includes the products using the product information.

In some alternative embodiments, the tag setting module is further used for acquiring an incentive period for each product; and adding each product into the product list according to the incentive period of each product;

during the playback of the video, the tag management module is used for acquiring the current time of the video when receiving the first preset signal; and the touch signal acquiring module is used for displaying the product list and determining whether the current time is in an incentive period of a product, and if yes, then displaying the product in the product list; if no, then hiding the product; and repeating the above process until all the products are traversed.

In some alternative embodiments, the product tag includes a product section, wherein the product section is an area including a single product displayed on the video screen and the product section is highlighted by bolding edges, masking, highlighting, etc.;

the tag setting module is used for acquiring the product information of all products to be added; acquiring an incentive period for each product; and adding the product sections into the video according to the incentive period of each product;
during the playback of the video, the tag management module is used for acquiring the current time of the video when receiving the first preset signal; determining whether the current time is in an incentive period of any product, and if yes, then displaying the product section of the product; if no, then hiding the product section of the product; and repeating the above process until all the products are traversed.

In some alternative embodiments, the tag setting module is used for assigning a product tag identification number to the product tag; acquiring a video identification information of the video and associating the video identification information with the product tag identification number; and

during the playback of the video, the tag management module is used for retrieving the product tag identification number associated with the current video identification information of the video according to the video identification information of the current video, and loading the product tag corresponding to the product tag identification number.

In some alternative embodiments, the first preset signal is any one of light pressing, tapping, swiping and panning signals; the second preset signal is any one of heavy pressing, tapping, swiping and panning signals; and the second preset signal is different from the first preset signal.

Yet another aspect of an embodiment of the present disclosure further provides a device, an embodiment of the device including:

a touch screen for receiving a touch signal;

one or more processor(s); and

a memory for storing an operating instruction;

wherein the one or more processor(s) is/are configured to acquire the operation instruction from the memory to execute the steps of:

adding a product tag for implementing a shopping function into a video;

acquiring a touch signal within the display area of the video during video playing; and

if the touch signal is a first preset signal, then displaying the product tag of the video; or

if the touch signal is a second preset signal, then retrieving a purchasing link of the product indicated by the second preset signal via the product tag and displaying the purchasing link.

In some alternative embodiments, the product tag includes a menu product list which includes product information. The processor is further used for executing the steps of:

acquiring the product information of all products to be added; and

making a product list which includes the products using the product information.

In some alternative embodiments, the processor is further used for executing the steps of:

acquiring an incentive period for each product;

adding each product into the product list according to the incentive period of each product;

acquiring the current time of the video when receiving the first preset signal; and

displaying the product list and determining whether the current time period is in an incentive period of one product, and if yes, then displaying the product in the product list; if no, then hiding the product; and repeating the above process until all the products are traversed.

In some alternative embodiments, the product tag includes a product section, wherein the product section is an area including a single product displayed on the video screen and the product section is highlighted by bolding edges, masking, highlighting, etc.; and the processor is further used for executing the steps of:

acquiring the product information of all products to be added;

acquiring an incentive period for each product;

adding the product sections into the video according to the incentive period of each product;

acquiring the current time of the video when receiving the first preset signal; and

determining whether the current time is in an incentive period of any product, and if yes, then displaying the product section of the product; if no, then hiding the product section of the product; and repeating the above process until all the products are traversed.

In some alternative embodiments, the processor is further used for executing the steps of:

assigning a product tag identification number to the product tag;

acquiring a video identification information of the video and associating the video identification information with the product tag identification number; and

during the playback of the video, according to the video identification information of the current video, retrieving the product tag identification number associated with the video identification information of the current video, and loading the product tag corresponding to the product tag identification number.

In some alternative embodiments, the first preset signal is any one of light pressing, tapping, swiping and panning signals; the second preset signal is any one of heavy pressing, tapping, swiping and panning signals; and the second preset signal is different from the first preset signal.

As can be seen from the above, the method, system and device for implementation of video shopping provided by the embodiments of the present disclosure employs a multi-dimensional touch technology to achieve that during the playback of a video, the product information can be known at any time via the touch actions to the screen to conveniently implement video shopping, and when the video interface is touched once by the user, it can display a product tag and when the specific tag is touched again, a purchasing link will be triggered, which provides a brand-new, simple and intuitive video shopping mode to greatly simplify the operation of a video shopping.

It should be understood that both the descriptions in general and in detailed are exemplary and explanatory without any limit to the invention.

### BRIEF DESCRIPTION OF DRAWINGS

FIG. 1 is a schematic flow diagram of a method for implementing video shopping according to some embodiments of the present disclosure;

FIG. 2 is a schematic flow diagram of a method for implementing video shopping according to some embodiments of the present disclosure;

FIG. 3 is a schematic flow diagram of a method for implementing video shopping according to some embodiments of the present disclosure;

FIG. 4 is a schematic flow diagram of a method for implementing video shopping according to a first expanded example of the present disclosure;

FIG. 5 is a schematic view showing a method for implementing video shopping under the status of light pressing according to a first expanded example of the present disclosure;

FIG. 6 is a schematic view showing a method for implementing video shopping under the status of light pressing according to a second expanded example of the present disclosure;

FIG. 7 is a schematic flow diagram of a method for implementing video shopping according to a third expanded example of the present disclosure;

FIG. 8 is another schematic flow diagram of a method for implementing video shopping according to a third expanded example of the present disclosure;

FIG. 9 is a schematic view showing a method for implementing video shopping under the status of light pressing according to a third expanded example of the present disclosure;

FIG. 10 is a schematic flow diagram of a method for implementing video shopping according to a forth expanded example of the present disclosure;

FIG. 11 is another schematic flow diagram of a method for implementing video shopping according to a forth expanded example of the present disclosure;

FIG. 12 is another schematic flow diagram of a method for implementing video shopping according to a forth expanded example of the present disclosure;

FIG. 13 is a schematic view showing a method for implementing video shopping when light pressing on the area outside the product section according to a forth expanded example of the present disclosure;

FIG. 14 is another schematic flow diagram of a method for implementing video shopping according to a forth expanded example of the present disclosure;

FIG. 15 is a schematic view showing a method for implementing video shopping when light pressing within a product section according to the forth expanded example of the present disclosure;

FIG. 16 is another schematic flow diagram of a method for implementing video shopping according to a forth example of the present disclosure;

FIG. 17 is a schematic view of a system for implementing video shopping according to some embodiments of the present disclosure.

The embodiments of the present disclosure have been clearly illustrated through the drawings and will be described in detail hereinafter. These drawings and text description are not intent in any way to limit the scope of the disclosure, but illustrate the concept of the disclosure for the skilled in the art by reference to specific embodiments.

### DETAILED DESCRIPTION

The present disclosure is described more fully hereinafter with reference to the accompanying drawings so that the objects, technical solutions and advantages of the present disclosure will become more apparent.

It will be understood that, the terms “first”, “second” etc. used herein is to distinguish various elements or parameters with the same name for the convenience. The embodiments of the present disclosure should not be limited by these terms and the specific description of these terms for the embodiments would be omitted hereinafter.

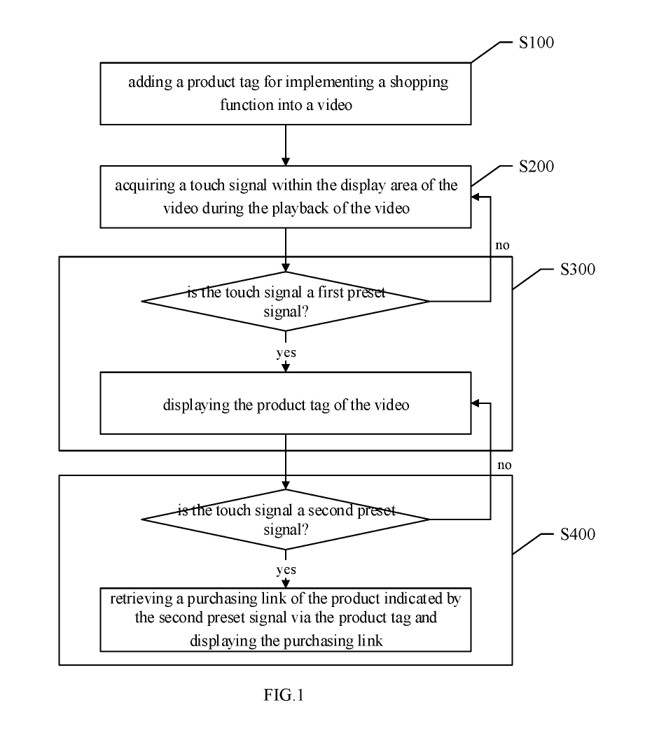

FIG. 1 is a schematic flow diagram of a method for implementing video shopping according to an embodiment of the present disclosure.

As shown in the figure, a method for implementation of video shopping provided by the present disclosure includes the steps of:

S100: adding a product tag for implementing a shopping function into a video;

S200: acquiring a touch signal within a display area of the video during the playback of the video;

S300: if the touch signal is a first preset signal, then displaying the product tag of the video; wherein the product tag includes product information of the product in the video, and the product information includes but not limited to the name, sample pictures, brief introduction and purchasing link of the product; and

S400: if the touch signal is a second preset signal, then retrieving a purchasing link of the product indicated by the second preset signal via the product tag and displaying the purchasing link.

Alternatively, the first preset signal is any one signal of light pressing, tapping, swiping and panning; the second preset signal is any one signal of heavy pressing, tapping, swiping and panning; and the second preset signal is different from the first preset signal.

Preferably, the first preset signal is a light pressing signal and the second preset signal is a heavy pressing signal. The terms “light pressing” and “heavy pressing” mean that when the finger touches the screen and applies a pressure for a period of time, the relatively smaller pressure is determined as a light pressing and the relatively greater pressure is determined as a heavy pressing.

An alternative embodiment for distinguishing between light pressing and heavy pressing can be that:

measuring the touch pressure using a touch screen which has a pressure sensitive measurement function and determining the touch event is a light pressing or a heavy pressing by comparing the touch pressure with a preset first pressure threshold, that is, the touch pressure greater than the first pressure threshold is determined as the heavy pressing and that less than or equal to the first pressure threshold is determined as the light pressing; or

monitoring the touch area (herein the touch area is merely for fingers) using a touch screen which is able to measure the touch area, wherein during the occurrence of the first touch event, if the contact area between the finger and the touch screen is smaller than the first touch area threshold, it is determined as the light pressing, and during the occurrence of the second touch event, if the contact area between the finger and the touch screen is larger than the first touch area threshold, it is determined as the heavy pressing; or

combining the pressure with the touch area to determine, for example, if the touch pressure is smaller than the first pressure threshold and/or the touch area is smaller than the first touch area threshold, it is determined as the light pressing, and if the touch pressure is greater than the first pressure threshold and/or the touch area is larger than the first touch area threshold, it is determined as the heavy pressing.

The above-mentioned means to distinguish between light pressing and heavy pressing also can be implemented by the current terminal devices which have 3D Touch Technology, such as iPhone 6S, iPhone 6S plus, iPad pro and future devices having IOS9.0 and above operating system.

The shopping method of the embodiment cannot affect the user to use the gestures of the existing video player which usually employs the tapping action to control the pause/play of the video. But in the shopping method of the embodiment, when the user expects to view the product information of the product shown in the video, the product tag will be displayed via the user's light pressing action on the screen, at this time, the user can browse the product introduction and the video playback will be paused. If the product is not the product of interest, the user can release the finger to make the product tag disappear and continue to watch the video.

Hereinafter, the embodiments will be described by assuming the first preset signal is a light pressing signal and the second preset signal is a heavy pressing signal, and the signals will be described as light pressing signal and heavy pressing signal.

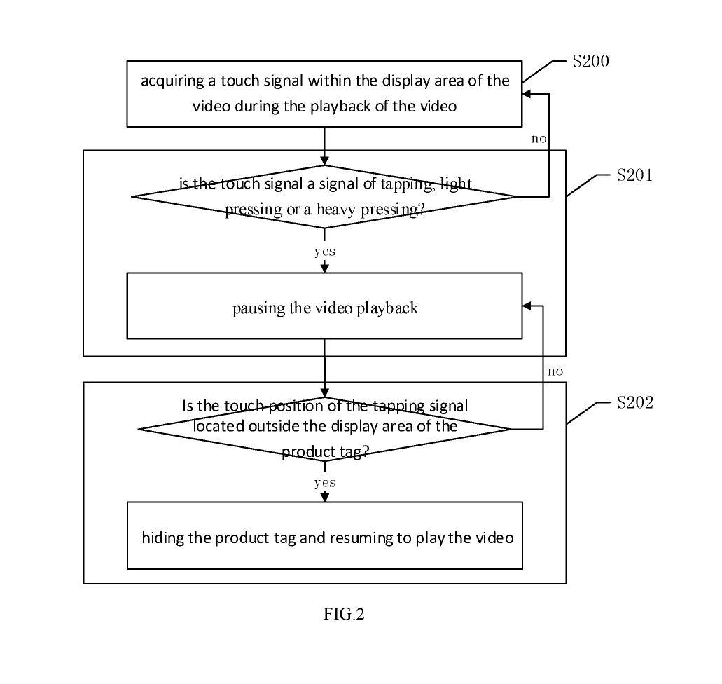

FIG. 2 is another schematic flow diagram of a method for implementing video shopping according to an embodiment of the present disclosure. As shown, alternatively, the method further includes the step of S201: if the touch signal is a signal of tapping, light pressing or a heavy pressing, then pausing the video playback.

When the user expects to browse a brief description of product appeared in the video, in order to avoid missing the next content, the user may choose to pause the video playback, so this function can be combined into the step of acquiring a touch signal of the embodiment, that is, as long as receiving a touch action of light pressing, the video playback will be paused. This function can be turned on or off by decision of the user.

Further, the method includes a step of S202: when the product tag is in a display status, if acquiring a new tapping signal and the touch position of the tapping signal is located outside the display area of the product tag, then hiding the product tag and resuming to play the video.

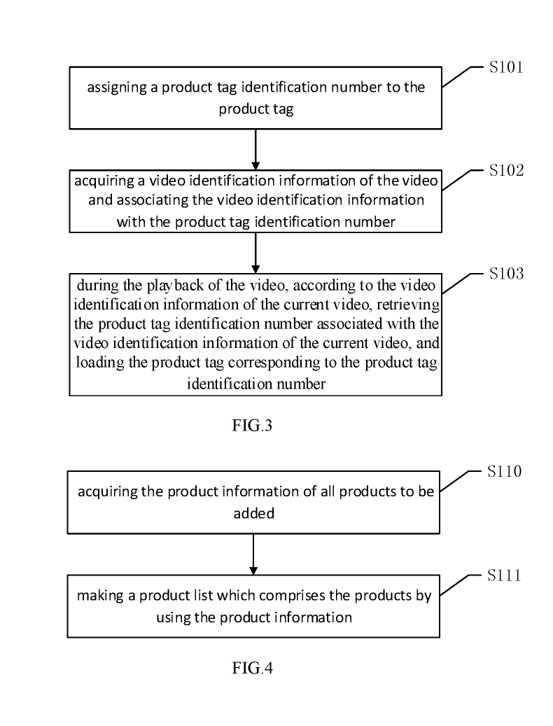

FIG. 3 is another schematic flow diagram of a method for implementing video shopping according to an embodiment of the present disclosure. As shown, the step of S100 for adding a product tag for implementing a shopping function into a video can further include the sub-steps of:

S101: assigning a product tag identification number to the product tag;

S102: acquiring a video identification information of the video and associating the video identification information with the product tag identification number; and

S103: during the playback of the video, according to the video identification information of the current video, retrieving the product tag identification number associated with the video identification information of the current video, and loading the product tag corresponding to the product tag identification number.

The above sub-steps assign an identification number to the product tag and associate the video identification information of the video with the product tag identification number. In this manner, the product tag can be stored locally or in the server which can be downloaded as required, and can avoid the affection to the video when editing the product tag, so as to enhance the flexibility of the product list when being modified or edited.

Of course, for some videos with short or fixed content without any changes substantially, the product tag can be bound with the video in advance and added into the video content as an annex.

### The First Expanded Example

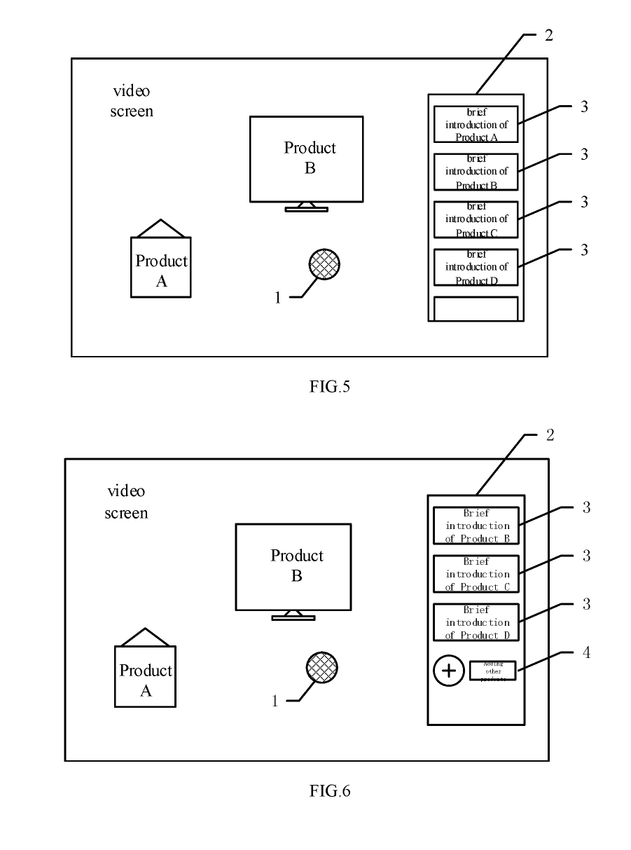

FIG. 4 is a schematic flow diagram of a method for implementing video shopping according to the first expanded example of the present disclosure; and FIG. 5 is a schematic view showing a method for implementing video shopping under the status of light pressing according to the first expanded example of the present disclosure.

As shown, in this expanded example, the product tag includes a menu product list and the menu product list is provided with a product option in which the product information is displayed.

Furthermore, the step of S100 for adding a product tag into the video can include the sub-steps of:

S110: acquiring the product information of all products to be added, wherein the product information includes, but not limited to, the name, sample pictures, brief introduction and purchasing link of the product; and

S111: making a product list which includes the products using the product information.

Referring to FIG. 5, in this example, after receiving a light pressing signal 1 located within the display area of the video player, the product list 2 is ejected from a side of the video screen, in which all preset product options 3 shown in the video are provided. The user can acquire a purchasing link corresponding to the product by up-down panning, swiping the product options 3 and heavy pressing one product option 3.

In other alternative embodiments, the product list can be bound with the video as a video annex to generate a single file.

The first expanded example which is easy to be implemented and the content of the product list is relatively fixed and easy to make is applicable for short video having less products. However, when the video has a long time and a large number of products which are shown in the video, the above product list will be very long and inconvenient to the up-down sliding searching. Thus, the following modifications are provided.

### The Second Expanded Example

FIG. 6 is a schematic diagram of a method for implementing video shopping under the status of light pressing according to the second expanded example of the present disclosure.

As shown, in this example, based on the first expanded example, the product list 2 is provided with an adding option 4 for adding a new product item.

If the user cannot find a product shown in the video in the product list 2, the user can choose the adding option 4 to acquire an advisory by describing the time point, position, appearance, etc. of the product when it appears in the video and the messages input by the user can be synchronized into the video comment area for discussion and answered by other users. If the user has already know the information of the product, the user also can choose the adding option 4 to actively add a new product option which can be stored locally and only be seen by the user. The new product option can be uploaded into the server and added the original product list 1 after checked and passed by the staffs, and at this time, the product option can be seen by all users watching the video.

The first expanded embodiment is easy to be implemented and the content of the product list is relatively fixed and easy to make is applicable for short video having less products. However, when the video has a long time and a large number of products which are shown in the video, the above product list will be very long and inconvenient to the up-down sliding searching. Thus, the following modifications are provided.

### The Third Expanded Example

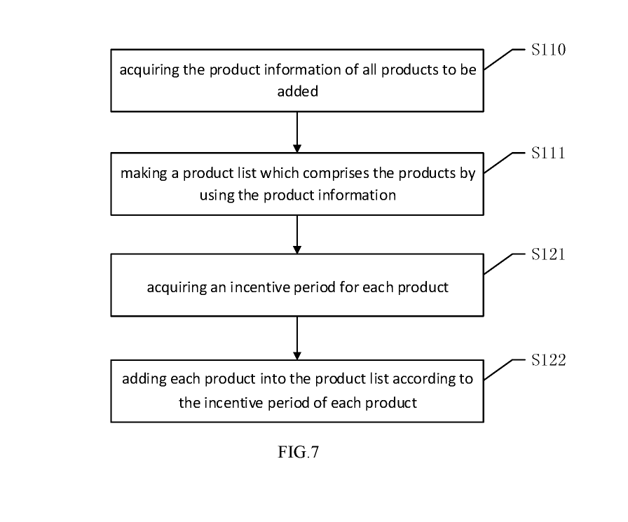

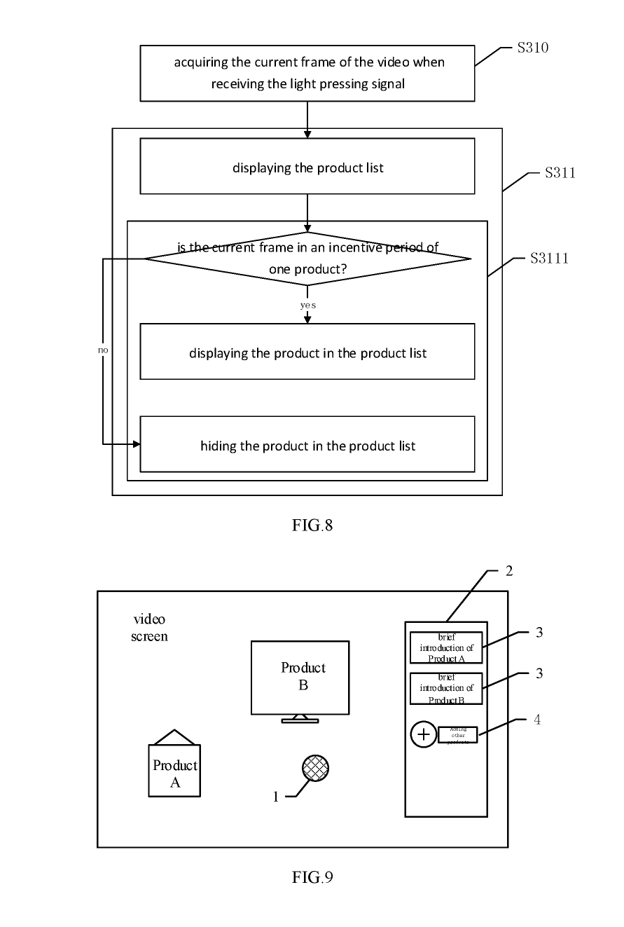

FIG. 7 is a schematic flow diagram of a method for implementing video shopping according to the third expanded example of the present disclosure; FIG. 8 is another schematic flow diagram of a method for implementing video shopping according to the third expanded example of the present disclosure; and FIG. 9 is a schematic view showing a method for implementing video shopping under the status of light pressing according to the third expanded example of the present disclosure.

As shown, in this expanded example, the product tag is still a menu product list. When the video has a long time and a large number of products which are shown in the video, the product list containing all products shown in the video will be very long to be inconvenient to the user retrieving the product of interest, so that the third example is provided.

Referring to FIG. 7, the step of S100 for adding a product tag into the video further includes the sub-steps of:

S121: acquiring an incentive period for each product.

This step follows the step of S111, wherein after acquiring the product information of all products to be added, the incentive period for each product is further acquired. The incentive period may be several discrete time sections corresponding to the time sections of each product shown in the video, that is, when one product is shown in the video, an incentive start point is added, and when the product is disappeared in the video, an incentive end point is added. When the product is shown again, the process is repeated. The period between the incentive start point and the incentive end point is the incentive period of the product shown in the video. The incentive period can be predetermined by the period of each product shown in the video during the playback of the video.

S122: adding each product into the product list according to the incentive period of each product.

In the product list, each product is an option in which the name, sample pictures and brief introduction of the product are displayed. The difference from the first expanded example is that in the product list of this example, the option for each product can additionally have a hidden contribution of “incentive period” as a reason of determining whether a product option is shown in the product list when the user's light pressing action is occurred.

Further, referring to FIG. 8, the step of S300 for acquiring a light pressing signal and displaying the product tag includes the sub-steps of:

S310: acquiring the current frame of the video when receiving the light pressing signal; and

S311: displaying the product list and if the current frame is in an incentive period of one product, then displaying the product in the product list.

Specifically, the step of S311 for displaying a product in the product list according to the incentive period of each product can includes the secondary sub-steps of:

S3111: determining whether the time point of the current frame is in the incentive period of a product, if yes, then displaying the product in the product list; if no, then hiding the product; and repeating the process until all the products tare traversed.

When receiving the light pressing signal, the video frame at this time point is acquired and the time point of the video frame in the video is searched, and the time point is compared with the incentive period of all products in the video. If the time point is in an incentive period of a product, then the option of the product is displayed in the product list, otherwise, the option of the product is hidden. For the user, it is shown that only the product information appeared in the current video screen can be displayed.

As shown in FIG. 9, only product A and product B are shown in video screen at this time, after receiving a light pressing signal 1 located within the display area of the video player, the product list 2 is ejected from a side of the video screen. The product list 2 only contains product options 3 of the product A, and the product B shown in the current video screen. The user can acquire the purchasing link corresponding the product by up-down panning to scroll the product options 3 and heavy pressing a product option 3.

Alternatively, the example can be combined with the second example, so that the product list 2 can be further provided with an adding option 4 for adding a new product item.

In the above three expanded examples, although the product information shown in a manner of product list has a clear interface, the operation is slightly complicated. Thus, an example with more instinct and simple operation is provided.

### The Forth Expanded Example

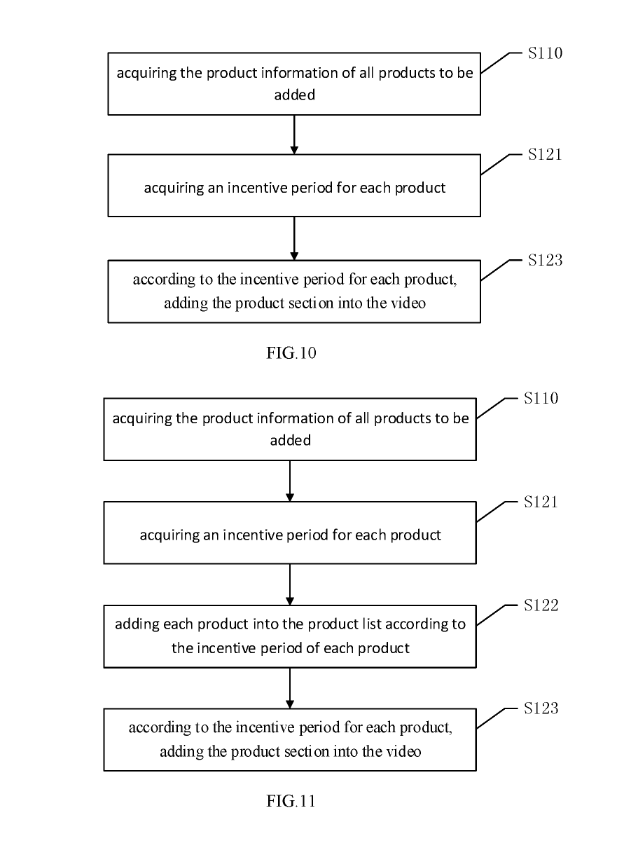

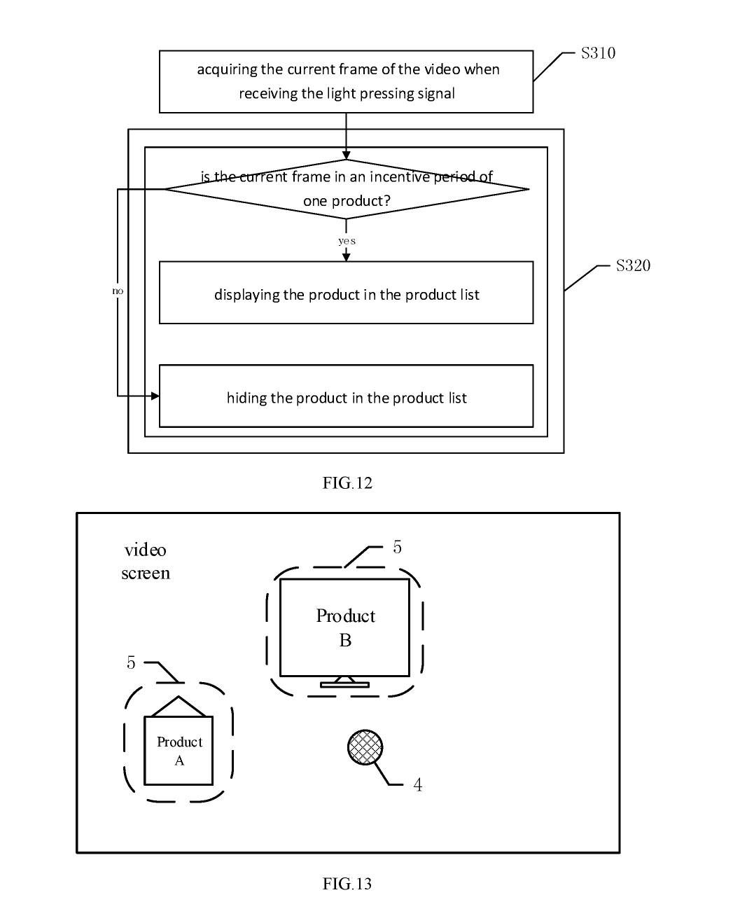

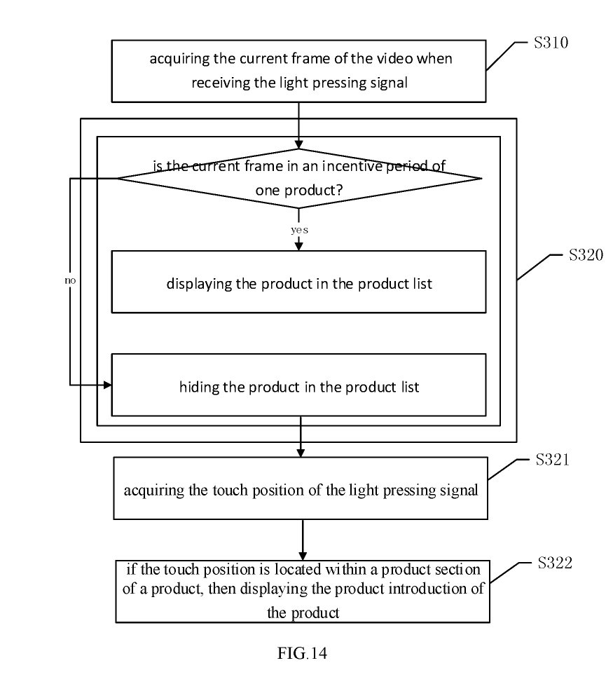

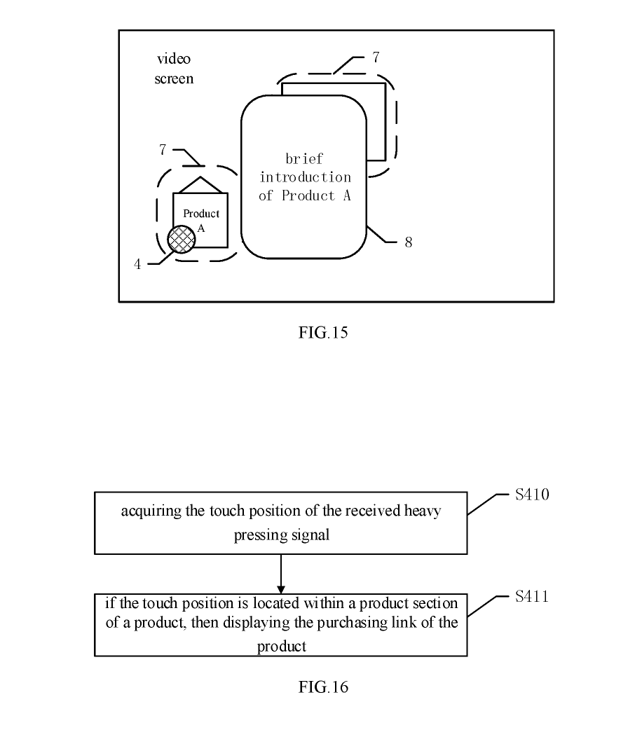

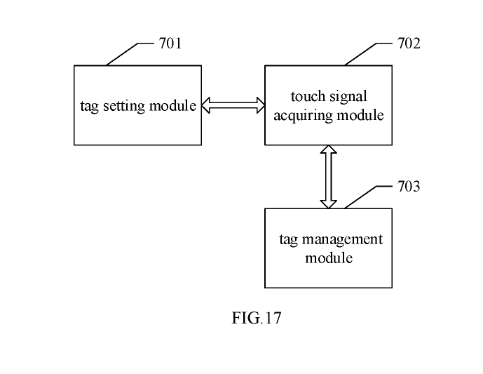

FIG. 10 is a schematic flow diagram of a method for implementing video shopping according to the forth expanded example of the present disclosure; FIG. 11 is another schematic flow diagram of a method for implementing video shopping according to the forth expanded example of the present disclosure; FIG. 12 is another schematic flow diagram of a method for implementing video shopping according to the forth expanded example of the present disclosure; FIG. 13 is a schematic view showing a method for implementing video shopping when light pressing on the area outside the product section according to the forth expanded example of the present disclosure; FIG. 14 is another schematic flow diagram of a method for implementing video shopping according to the forth expanded example of the present disclosure; FIG. 15 is a schematic view showing a method for implementing video shopping when light pressing within the product section according to the forth expanded example of the present disclosure; and FIG. 16 is another schematic flow diagram of a method for implementing video shopping according to the forth expanded example of the present disclosure;

In this example, the product tag includes a product section.

Further, as shown in FIG. 10, the step of S100 for adding the product tag into the video includes the sub-steps of:

S123: according to the incentive period for each product, adding the product section into the video.

The product section is an area containing a single product which is as small as possible and includes the whole outer contour of the single product displayed in the video or the whole outer contour of a single product displayed in the video as possible (for example, some products without completely shown in the current screen or which cannot be completely surrounded due to a complicated shape). The product sections can be highlighted by bolding edges, masking, highlighting, etc., such as product section 5 in FIG. 13 and FIG. 15. Since the angles and sizes of the product are constantly changing during the video playback, the shapes of the product section is varied by the progress of video playback. The product section can be automatically added into the video by recognizing the outer contour of the product via an image processing software or manually added into the video after the product scope and the shapes of the product section are determined by the staffs in advance.

This step can follow the above step of S121 (referring to FIG. 10) or the step of S122 (referring to FIG. 11). If following the step of S121, that is, displaying the product list and the product section at the same time.

Further, with reference to FIG. 12, the step of S300 for acquiring a light pressing signal and displaying the product tag includes the sub-steps of:

S320, if the current frame is in an incentive period of a product, then displaying the product section of the product.

This step follows the step of S310, including after acquiring the current frame at the time of receiving the light pressing signal, if the current frame is in the incentive period of a product, then displaying the product section of the product. Similar to the third expanded example, the incentive period is some discrete time sections, in which the product section is expected to be displayed, and out of which the product section is expected to be hidden. That is, determining whether the time point of the current frame is in an incentive period of a product, if yes, then displaying the product section of the product; if no, then hiding the product section of the product; and repeating the above process until all products are traversed.

As shown in FIG. 13, at this time the video screen contains the product A and the product B, after receiving a light pressing signal 1 located within the display area of the video player, the product sections 5 of the product A and the product B can be displayed by the manners such as highlighting, additional contour lines, etc. At this time, if receiving a tapping signal 1 located within the product section of the product A, as shown in FIG. 15, then displaying the product introduction 6 of the product A including the name, sample pictures, text description of the product A. The purchasing link corresponding to the product can be acquired by heavy pressing a product section 5.

Alternatively, referring to FIG. 14, the step of S300 for acquiring a light pressing signal and displaying the product section further includes the sub-steps of:

S321: acquiring the touch position of the light pressing signal; and

S322: if the touch position is located within a product section of a product, then displaying the product introduction of the product.

Preferably, as shown in FIG. 15, the introduction can be displayed beside the product section by using a manner of suspension frame or displayed at other location within the display area of the video.

Further, referring to FIG. 16, the step of S400 for acquiring a heavy pressing signal and displaying the product purchasing link can further include the sub-steps of:

S410: acquiring the touch position of the received heavy pressing signal; and

S411, if the touch position is located within a product section of a product, then displaying the purchasing link of the product.

Taking into account that the user may want to directly obtain the introduced product by light pressing, thus it is added for a function of directly triggering the product introduction by light pressing and a function of acquiring the purchasing link by heavy pressing.

The expanded example adds an arrangement of product section comparing with the above three expanded examples. When the user sees a product of interest, the user can touch the video player interface to highlight the current time point and the product sections of all the products shown in the video screen can be chosen by the user. At the same time, a product list will be displayed in the video and the user can browse the product introduction corresponding to the product by tapping any section. Preferably, when the user taps on the product section of any product, the product list will automatically slide into the product option corresponding to the product section in the product list. Comparing with the operation manner of simple list, the example does not need to employ a manual page turning and the sections highlighted in the video interface also can provide a reminder, so that the user's shopping can be more convenient.

Alternatively, the example can be implemented individually without addition of product list, but only employ a product section to prompt the product. When receiving the instruction of light pressing, if it is detected that the touch position is located within the area of a product section, then displaying the product section and displaying a product introduction frame of the contained product beside the product section.

The method for implementation of video shopping are described by some embodiments hereinbefore, and now it is discussed a system for implementation of video shopping.

FIG. 17 is a schematic view of a system for implementing video shopping according to an embodiment of the present disclosure.

As shown, a system for implementation of video shopping in the embodiment includes:

a tag setting module 701, for adding a product tag for implementing a video shopping function into a video;

a touch signal acquiring module 702, for playing a video and acquiring a touch signal within the display area of the video during the playback of the video; and

a tag management module 703, for identifying the touch signal; if the touch signal is a first preset signal, then controlling the touch signal acquiring module 702 to display the product tag of the video; or if the touch signal is a second preset signal, then it is used for retrieving a purchasing link of the product indicated by the second preset signal via the product tag and displaying the purchasing link.

Alternatively, the product tag is a menu product list which includes product information; and the tag setting module 701 is used for acquiring the product information of all products to be added; acquiring an incentive period for each product; and adding each product into the product list according to the incentive period of each product; the tag management module 703 is used for acquiring the current frame of the video when receiving the light pressing signal; and the touch signal acquiring module 702 is used for displaying the product list and if the current frame is in an incentive period of a product then controlling the touch signal acquiring module 702 to display the product in the product list.

Further, the tag management module 703 is used for determining whether the time point of the current frame is in an incentive period of a product, if yes, then controlling the touch signal acquiring module 702 to display the product in the product list; if no, then controlling the touch signal acquiring module 702 to hide the product; and repeating the above process until all the products to are traversed.

Further, the product tag includes a product section, wherein the product section is an area including single product displayed on the video screen and the product section is highlighted by bolding edges, masking, highlighting, etc.; the tag setting module 701 is used for acquiring the product information of all products to be added; acquiring an incentive period for each product; and according to the incentive period of each product, adding the product section into the video; the tag management module 703 is used for acquiring the current frame of the video when receiving the light pressing signal; if the current frame is in the incentive period of a product then controlling the touch signal acquiring module 702 to display the product section of the product.

Further, the tag management module 703 is used for determining whether the time point of current frame is in the incentive period of a product, if yes, then controlling the touch signal acquiring module 702 to display the product section of the product; if no, then controlling the touch signal acquiring module 702 to hide the product section of the product; and repeating the above process until all the products to be accessed.

Further, the tag setting module 701 is used for assigning a product tag identification number to the product tag; acquiring a video identification information of the video and associating the video identification information with the product tag identification number; and during the playback of the video, the tag management module 703 is used for retrieving the product tag identification number associated with the current video identification information of the video, and loading the product tag corresponding to the product tag identification number.

Yet another aspect of the present disclosure also provides a device for implementation of video shopping and one embodiment of the device includes:

a touch screen for receiving a touch signal and displaying a screen;

one or more processor(s), optionally, the one or more processor(s) is/are used for executing the steps defined by the methods of any one or more above-described embodiments; and

a memory for storing an operating instruction;

wherein the one or more processor(s) is/are configured to acquire the operation instruction from the memory to execute the steps of:

adding a product tag for implementing a shopping function into a video;

acquiring a touch signal within the display area of the video during the playback of the video; and

if the touch signal is a first preset signal, then displaying the product tag of the video; or

if the touch signal is a second preset signal, then retrieving a purchasing link of the product indicated by the second preset signal via the product tag and displaying the purchasing link.

In some alternative embodiments, the product tag includes a menu product list which includes product information. The processor is further used for executing the steps of:

acquiring the product information of all products to be added; and

making a product list which includes the products by using the product information.

In some alternative embodiments, the processor is further used for executing the steps of:

acquiring an incentive period for each product; and

adding each product into the product list according to the incentive period of each product;

acquiring the current time of the video when receiving the first preset signal; and

displaying the product list and determining whether the current time period is in an incentive period of one product, and if yes, then displaying the product in the product list; if no, then hiding the product; and repeating the above process until all the products are traversed.

In some alternative embodiments, the product tag includes a product section, wherein the product section is an area including a single product displayed on the video screen and the product section is highlighted by bolding edges, masking, highlighting, etc.; and the processor is further used for executing the steps of:

acquiring the product information of all products to be added;

acquiring an incentive period for each product;

adding the product sections into the video according to the incentive period of each product;

acquiring the current time of the video when receiving the first preset signal; and

determining whether the current time is in an incentive period of any product, and if yes then displaying the product section of the product; if no then hiding the product section of the product; and repeating the above process until all the products are traversed.

In some alternative embodiments, the processor is further used for executing the steps of:

assigning a product tag identification number to the product tag;

acquiring a video identification information of the video and associating the video identification information with the product tag identification number; and

during the playback of the video, according to the video identification information of the current video, retrieving the product tag identification number associated with the video identification information of the current video, and loading the product tag corresponding to the product tag identification number.

In some alternative embodiments, the first preset signal is any one of light pressing, tapping, swiping and panning signals; the second preset signal is any one of heavy pressing, tapping, swiping and panning signals; and the second preset signal is different from the first preset signal.

The method, system and device for implementation of video shopping provided by the embodiments of the present disclosure employs a multi-dimensional touch technology to achieve that during the playback of a video, the product information can be known at any time via the touch actions to the screen to conveniently implement video shopping, and when the video interface is touched once by the user, it can display a product tag and when the specific tag is touched again, a purchasing link will be triggered, which provides a brand-new, simple and intuitive video shopping mode to greatly simplify the operation of a video shopping.

In addition, typically, the device of the present disclosure can be a variety of electronic terminal devices such as mobile phone, personal digital assistant (PDA), tablet PC (PAD), smart TV, etc., so that the scope of the disclosure should not be limited to a specific type of electronic device. The system of the present disclosure can be applied in any one of the above electronic terminal device in the form of electronic hardware, computer software or a combination thereof.

Furthermore, the method according to the present disclosure may also be implemented as a computer program executed by CPU, and the computer program may be stored in a computer-readable storage medium. When the computer program is executed by CPU, the above functions defined in the methods of the present disclosure are executed.

Furthermore, the above-described method steps and system units can also be implemented by using a controller and a computer-readable storage medium for storing a computer program to make the controller to implement the above steps or unit functions.

Additionally, it should be appreciated that the computer-readable storage medium as described herein (for example, memory) may be volatile memory or nonvolatile memory, or can include both volatile memory and nonvolatile memory. As an example without any limitation, nonvolatile memory can include read only memory (ROM), programmable ROM (PROM), electrically programmable ROM (EPROM), electrically erasable programmable ROM (EEPROM), or flash memory. Volatile memory can include random access memory (RAM) which can act as external cache RAM memory. As an example without any limitation, RAM is available in many forms, such as synchronous RAM (DRAM), dynamic RAM (DRAM), synchronous DRAM (SDRAM), double data rate SDRAM (DDR SDRAM), enhanced SDRAM (ESDRAM), sync link DRAM (SLDRAM) and direct RambusRAM (DRRAM). The disclosed aspects of the storage devices are intended to include, but not limited to these and other suitable types of memory.

Those skilled in the art will also understand that a combination of the illustrative logical sections, modules, circuits, and algorithm steps described in this disclosure may be implemented as electronic hardware, computer software, or both. To clearly illustrate the interchangeability between hardware and software, various illustrative components, sections, modules, circuits, and functions of steps have been generally described. Whether such function is implemented as software or hardware is depended on the particular application and the design constraints imposed on the whole system. Those skilled in the art can achieve the functions for each particular application in various ways, but such implementing decisions should not be interpreted as a departure from the scope of the present disclosure.

A combination of the illustrative logical sections, modules, and circuits can be implemented or executed by using the following components designed to perform the functions described herein: general purpose processor (GPP), digital signal processor (DSP), dedicated integrated circuit (ASIC), field programmable gate array (FPGA) or other programmable logic device, discrete gate or transistor logic, discrete hardware components or any combination thereof. The GPP may be a microprocessor, but in the alternative, the processor may be any conventional processor, controller, microcontroller, or state machine. The processor may also be implemented as a combination of computing devices, e.g., a combination of DSP and microprocessor, a plurality of microprocessors, one or more microprocessors with a DSP core, or any other such configuration.

A combination of the steps of method or algorithm described herein may be contained directly in hardware, software module executed by a processor, or both. The software module may reside in RAM memory, flash memory, ROM memory, EPROM memory, EEPROM memory, registers, hard disk, removable disk, CD-ROM known in the art or any other form of storage medium. An exemplary storage medium is coupled to the processor such that the processor can read information from the storage medium or write information to the storage medium. Alternatively, the storage medium may be integrated into the processor. The processor and the storage medium may reside in ASIC. ASIC may reside in a user terminal. In one alternative, the processor and the storage medium may reside as discrete components in a user terminal.

In one or more exemplary designs, the functions described herein may be implemented in hardware, software, firmware, or any combination thereof. If implemented in software, the functions may be transmitted as one or more instructions or codes stored on a computer readable medium or by a computer-readable medium. Computer-readable medium includes both computer storage medium and communication medium, and the communication medium includes any medium contributed to transmit a computer program from one place to another. The storage medium may be any available medium accessible by a general purpose or special purpose computer. As an example without any restriction, the computer-readable medium can include RAM, ROM, EEPROM, CD-ROM or other optical disk storage, magnetic disk storage or other magnetic storage devices, or can be any other medium for carrying or storing the desired program codes in the form of instruction or data structures and can be accessed by or via a general purpose or special purpose computer. Also, any connection can be properly termed as a computer-readable medium. For example, if using a coaxial cable, fiber optic cable, twisted pair, digital subscriber line (DSL) or wireless technologies such as infrared, radio, and microwave to transmit software from website, server, or other remote source, the coaxial cable, fiber optic cable, twisted pair, DSL, or wireless technologies such as infrared, radio, and microwave are included in the definition of medium. As used herein, the terms of disk and disc include CD-ROM disc (CD), laser disc, optical disc, digital versatile disc (DVD), floppy disk and Blu-ray disc where the disk usually reproduces data magnetically and the disc reproduces data optically with lasers. Combinations of the above should also be included within the scope of computer-readable medium.

It should be understood that various changes and modifications may be made to the exemplary embodiments disclosed herein, without departing from the scopes of the disclosure defined in the appended claims. The functions, steps and/or actions of the method claims disclosed herein do not have to be executed in any particular order. Furthermore, although elements of the present disclosure may be described or claimed as an individual form, but a plurality can also be envisaged unless explicitly restricted to single.

It should be understood that, as used herein, unless the context clearly supports exceptions, the singular forms “a” (“a”, “an”, “the”) is intended to include the plural forms. It should also be understood that “and/or” used herein is intended to include any and all possible combinations of one or more of the associated listed items.

The serial number of the embodiments herein is merely used for illustration without representing the merits of the embodiments.

Those ordinary skilled in the art will appreciate that all or part of the steps to achieve the above-described embodiments may be accomplished by hardware or by instructing relevant hardware via program, and the program may be stored in a computer readable storage medium such as read-only memory, magnetic disk or optical disc.

Those ordinary skilled in the art will appreciate that any of the embodiments discussed are exemplary only without intended to imply that the scopes of the present disclosure (including claims) are limited to these examples; the embodiments or the features in the different embodiments may be combined and the steps may be implemented in any order in accordance with the idea of the present disclosure, and there are many other variations of the different aspects of the present disclosure as described herein without description in the details for simplicity. Thus, any omissions, modifications, equivalent replacements and improvements made in the spirit and principles of the present disclosure should be included within the scopes of the present disclosure.

What is claimed is:

1. A method for implementation of video shopping, comprising:
adding a product tag for implementing a shopping function into a video;
acquiring a touch signal within a display area of the video during the playback of the video; and
if the touch signal is a first preset signal, then displaying the product tag of the video; or
if the touch signal is a second preset signal, then retrieving a purchasing link of the product indicated by the second preset signal via the product tag and displaying the purchasing link.

2. The method according to claim 1, wherein the product tag includes a menu product list which comprises product information; and the step of adding a product tag for implementing a shopping function into a video comprises:
acquiring the product information of all products to be added; and
making a product list which comprises the products using the product information.

3. The method according to claim 2, wherein the step of adding a product tag for implementing a shopping function into a video further comprises:
acquiring an incentive period for each product; and
adding each product into the product list according to the incentive period of each product; and
wherein the step of acquiring the first preset signal and displaying the product tag comprises:
acquiring the current time of the video when receiving the first preset signal; and
displaying the product list and determining whether the current time is in an incentive period of a product, and if yes, then displaying the product in the product list; if no, then hiding the product; and repeating the above process until all the products to are traversed.

4. The method according to claim 1, wherein the product tag includes a product section which is an area including a single product displayed on the video screen, and the product section is highlighted by bolding edges, masking, highlighting, etc.; wherein the step of adding a product tag for implementing a shopping function into a video comprises:
acquiring the product information of all products to be added;
acquiring an incentive period for each product;
adding the product sections into the video according to the incentive period of each product; and
the step of acquiring the first preset signal and displaying the product section comprises:
acquiring the current time of the video when receiving the first preset signal;
determining whether the current time is in an incentive period of a product, and if yes then displaying the product section of the product; if no then hiding the product section of the product; and repeating the above process until all the products are traversed.

5. The method according to claim 1, wherein the step of adding a product tag for implementing a shopping function into a video comprises:
assigning a product tag identification number to the product tag;
acquiring a video identification information of the video and associating the video identification information with the product tag identification number; and
during the playback of the video, according to the video identification information of the current video, retrieving the product tag identification number associated with the video identification information of the current video, and loading the product tag corresponding to the product tag identification number.

6. The method according to claim 1, wherein the first preset signal is any one of light pressing, tapping, swiping and panning signals; the second preset signal is any one of heavy pressing, tapping, swiping and panning signals; and the second preset signal is different from the first preset signal.

7. A system for implementation of video shopping, comprising:
a tag setting module, for adding a product tag for implementing a video shopping function into a video;
a touch signal acquiring module, for playing a video and acquiring a touch signal within a display area of the video during the playback of the video; and
a tag management module, for identifying the touch signal; if the touch signal is a first preset signal, then controlling the touch signal acquiring module to display the product tag of the video;
or if the touch signal is a second preset signal, then retrieving a purchasing link of the product indicated by the second preset signal via the product tag and displaying the purchasing link.

8. The system according to claim 7, wherein the product tag includes a menu product list which comprises product information; and wherein the tag setting module is used for acquiring the product information of all products to be added, and making a product list which comprises the products using the product information.

9. The system according to claim 8, wherein the tag setting module is further used for acquiring an incentive period for each product; and adding each product into the product list according to the incentive period of each product; and wherein
during the playback of the video, the tag management module is used for acquiring the current time of the video when receiving the first preset signal; and the touch signal acquiring module is used for displaying the product list and determining whether the current time is in an incentive period for one product, and if yes, then displaying the product in the product list; if no, then hiding the product; and repeating the above process until all the products are traversed.

10. The system according to claim 7, wherein the product tag includes a product section, wherein the product section is an area including a single product displayed on the video screen and the product section is highlighted by bolding edges, masking, highlighting, etc.; and wherein
the tag setting module is used for acquiring the product information of all products to be added; acquiring an incentive period for each product; and according to the incentive period of each product, adding the product sections into the video; and wherein
during the playback of the video, the tag management module is used for acquiring the current time of the video when receiving the first preset signal; determining whether the current time is in an incentive period of any product, and if yes then displaying the product section of the product; if no then hiding the product section of the product; and repeating the above process until all the products are traversed.

11. The system according to claim 7, wherein the tag setting module is used for assigning a product tag identification number to the product tag; obtaining a video identification information of the video and associating the video identification information with the product tag identification number; and wherein during the playback of the video, the tag management module is used for retrieving the product tag identification number associated with the current video identification information of the video according to the video identification information of the current video, and loading the product tag corresponding to the product tag identification number.

12. The system according to claim 7, wherein the first preset signal is any one of light pressing, tapping, swiping and panning signals; the second preset signal is any one of heavy pressing, tapping, swiping and panning signals; and the second preset signal is different from the first preset signal.

13. A device for implementation of video shopping, comprising:
a touch screen for receiving a touch signal;
one or more processor(s); and
a memory for storing an operating instruction;
wherein the one or more processor(s) is/are configured to acquire the operation instruction from the memory to execute the steps of:
adding a product tag for implementing a shopping function into a video;
acquiring a touch signal within the display area of the video during the playback of the video; and
if the touch signal is a first preset signal, then displaying the product tag of the video; or
if the touch signal is a second preset signal, then retrieving a purchasing link of the product indicated by the second preset signal via the product tag and displaying the purchasing link.

14. The device according to claim 13, wherein the product tag includes a menu product list which comprises product information, and wherein the processor is further used for executing the steps of:
acquiring the product information of all products to be added; and
making a product list which comprises the products using the product information.

15. The device according to claim 14, wherein the processor is further used for executing the steps of:
acquiring an incentive period for each product;
adding each product into the product list according to the incentive period of each product;
acquiring the current time of the video when receiving the first preset signal; and
displaying the product list and determining whether the current time period is in an incentive period of one product, and if yes then displaying the product in the product list; if no then hiding the product; and repeating the process until all the products are traversed.

16. The device according to claim 13, wherein the product tag includes a product section, wherein the product section is an area including a single product displayed on the video screen and the product section is highlighted by bolding edges, masking, highlighting, etc.; and wherein the processor is further used for executing the steps of:
acquiring the product information of all products to be added;
acquiring an incentive period for each product;
adding the product sections into the video according to the incentive period of each product;
acquiring the current time of the video when receiving the first preset signal; and
determining whether the current time is in an incentive period of any product, and if yes, then displaying the product section of the product; if no, then hiding the product section of the product; and repeating the above process until all the products are traversed.

17. The device according to claim 13, wherein the processor is further used for executing the steps of:
assigning a product tag identification number to the product tag;
acquiring a video identification information of the video and associating the video identification information with the product tag identification number; and
during the playback of the video, according to the video identification information of the current video, retrieving the product tag identification number associated with the video identification information of the current video, and loading the product tag corresponding to the product tag identification number.

18. The device according to claim 13, wherein the first preset signal is any one of light pressing, tapping, swiping and panning signals; the second preset signal is any one of heavy pressing, tapping, swiping and panning signals; and the second preset signal is different from the first preset signal.
